(19) United States
(12) Patent Application Publication
(10) Pub. No.: US 2006/0250369 A1
(43) Pub. Date: Nov. 9, 2006

(54) Keyboard controls for customizing table layouts

(76) Inventor: Oliver G. Keim, Reilingen (DE)

Correspondence Address: FISH & RICHARDSON, P.C., PO BOX 1022, MINNEAPOLIS, MN, 55440-1022, US

(21) Appl. No.: 11/125,972

(22) Filed: May 9, 2005

(51) Int. Cl. G09G 5/00

(52) U.S. Cl. 345/168

(57) ABSTRACT

Methods and systems, including computer program products, implementing techniques for customizing table layouts using keyboard controls. In one aspect, the techniques include displaying a table with one or more rows and columns of data, receiving keyboard input establishing input focus on a particular row or column of the table, and while the input focus is established on the particular row or column, receiving keyboard input customizing the layout of the particular row or column.

### BACKGROUND

The present invention relates to data processing by a digital computer, and more particularly to keyboard controls in computer applications.

Keyboard controls allow for computer applications to be controlled through the use of a keyboard. Each keyboard control specifies one or more keystrokes that, when entered, invoke an operation within the system.

Some computer applications provide keyboard controls for navigating tables displayed by the computer application. However, these computer applications typically do not provide keyboard controls for customizing the layout of a table, for example, for rearranging the order of the columns of the table, or for resizing the width of a particular column of the table. Typically, to perform a table layout customization in these computer applications, the user must manipulate the table using a mouse or stylus, or interact with a dialog box separate from the table to make choices from a list of options displayed in the dialog box.

### SUMMARY OF THE INVENTION

The present invention provides methods and systems, including computer program products, implementing techniques for customizing table layouts using keyboard controls. In one aspect, the techniques include displaying a table with one or more rows and columns of data, receiving keyboard input establishing input focus on a particular row or column of the table, and while the input focus is established on the particular row or column, receiving keyboard input customizing the layout of the particular row or column.

Particular implementations can include one or more of the following features.

The techniques can further include, prior to establishing input focus on a particular row or column, receiving keyboard input navigating between rows or columns of the table until the particular row or column is reached.

The techniques can further include, while input focus remains on the particular row or column, receiving keyboard input invoking additional functionality associated with the particular row or column. The additional functionality can include any one of a help function, a filter function, a data processing function, a column removal or a column addition function.

Customizing the layout can include any one or more of renaming, resizing, reordering, or sorting the particular row or column.

Establishing input focus on a particular row or column can include visually marking the particular row or column with a marking that distinguishes the row or column from other rows or columns of the table.

Each row or column can have a header area. Establishing input focus on a particular row or column can include establishing input focus on the header area for the particular row or column.

The invention can be implemented to realize one or more of the following advantages. The keyboard controls for customizing table layout allow users who cannot operate a mouse or stylus to perform table layout customizations using a keyboard. The keyboard input can be provided directly to the table itself. No additional dialog boxes are required. One implementation of the invention provides all of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

Like reference numbers and designations in the various drawings indicate like elements.

FIG. 1 illustrates a system in accordance with one implementation of the invention.

FIG. 2 illustrates a table.

FIG. 3 illustrates establishing input focus on a column of a table.

FIG. 4 illustrates navigating between columns of a table.

FIG. 5 illustrates a method in accordance with one implementation of the invention.

FIG. 6 illustrates operations that customize the layout of a row or column of a table.

FIG. 7 illustrates additional functionality that can be invoked on a row or column of a table.

### DETAILED DESCRIPTION

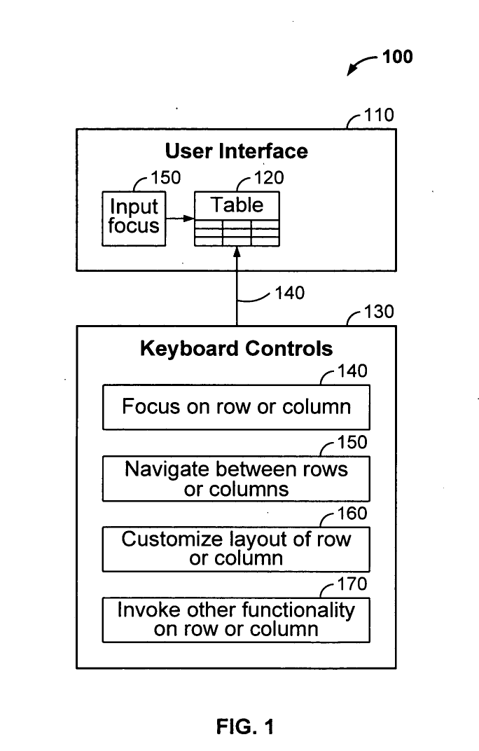

As shown in FIG. 1, a system 100 in accordance with one implementation of the invention includes a user interface 110. The user interface 110 includes one or more user interface elements. The user interface elements include a table 120.

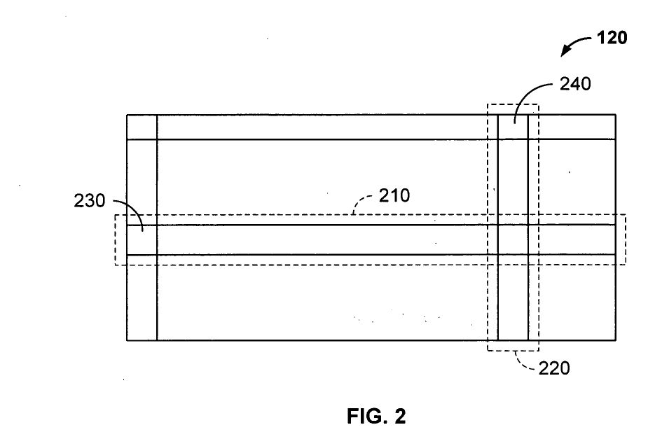

As shown in FIG. 2, the table 120 includes one or more rows 210 and columns 220. Each row 210 or column 220 can have a row header 230 or column header 240 that identifies the row 210 or column 220.

The system 100 also includes a set of keyboard controls 130. Each keyboard control 130 specifies one or more keystrokes that, when entered 140 while input focus 150 is on the table 120, invoke a particular operation on the table 120.

The set of keyboard controls 130 include the following keyboard controls:

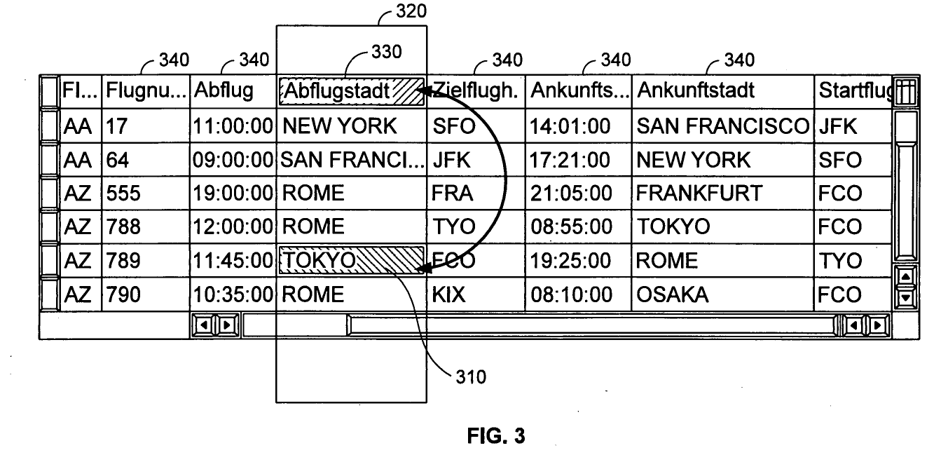

Keyboard controls 140 that establish input focus on a particular row or column of the table. For example, FIG. 3 shows input focus being shifted from a particular cell 310 of a table 300 to a particular column 320 of the table 300.

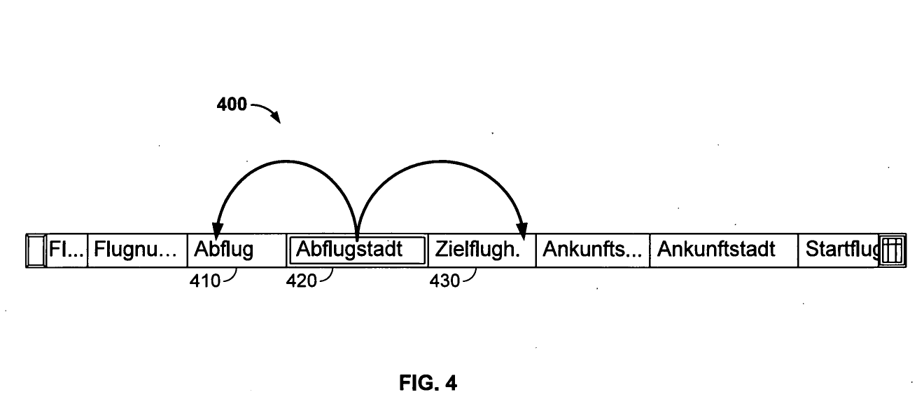

Keyboard controls 150 that navigate between rows or columns of the table. For example, FIG. 4 shows navigating between columns 410, 420, 430 of a table 400.

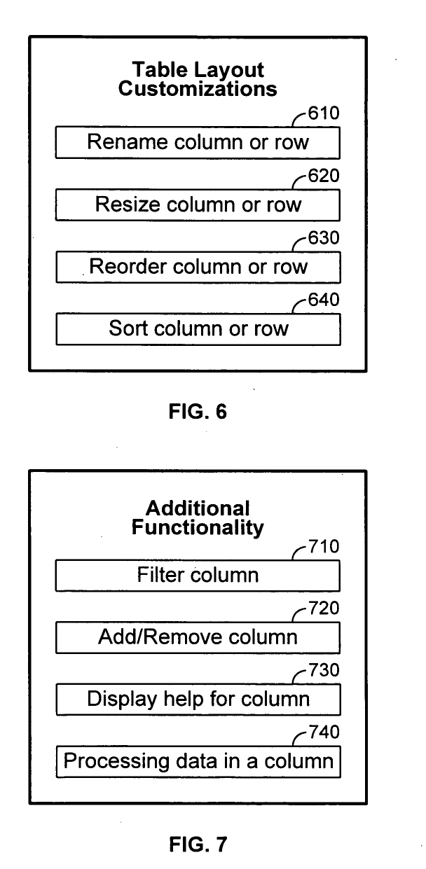

Keyboard controls 160 that customize the layout of a particular row or column of the table. As shown in FIG. 6, customizing the layout of a row or column of the table includes one or more of the following operations: renaming a column header or row header 610, resizing a column or row 620, rearranging the order of the row or column with respect to other rows or columns 630, and sorting the contents of a column or row 640.

Keyboard controls 170 that invoke other functionality on the particular row or column of the table. As shown in FIG. 7, the additional functionality includes one or more of the following operations: filtering columns 710, adding or removing columns from the table 720, displaying help information for a column 730, selecting and processing the contents of a column 740.

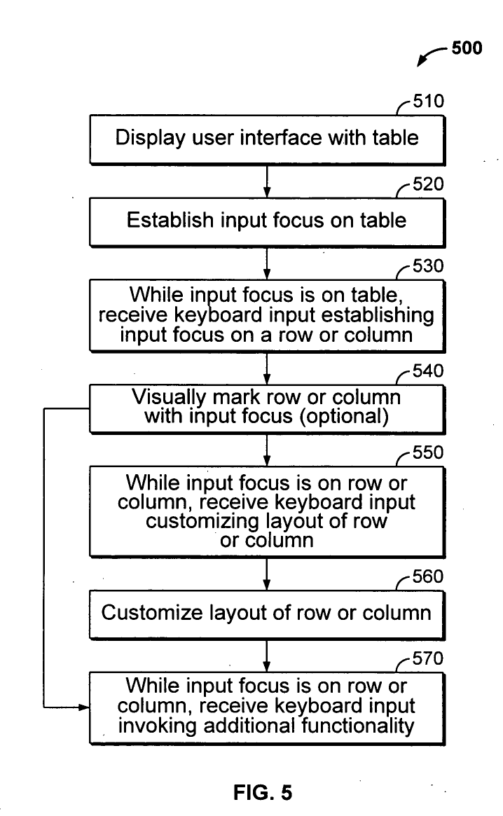

As shown in FIG. 5, during system operation, the system 100 displays the user interface 110 that includes the table 120 (step 510).

The system 100 establishes input focus on the table 120 (step 520). Establishing input focus on the table 120 can involve shifting input focus away from another element of the user interface 110.

The system 100 then receives keyboard input entered while input focus is on the table (step 530). The keyboard input includes one or more keystrokes that cause input focus to be established on a particular row or column of the table.

The system 100 can visually mark the row or column that has input focus (step 540). The system 100 can also visually mark the prior focus position with a different marking. This marking can be a dedicated color that is used throughout the entire user interface to represent inactive selections. As shown in FIG. 3, the column header 330 for the column 320 with input focus appears in a different color than the other column headers 340. Also, the cell 310 that previously held the input focus, has a different background color than the other cells.

While input focus is on the particular row or column, the system 100 receives keyboard input customizing the layout of the particular row or column (step 550).

In response to the received keyboard input, the system 100 customizes the layout of the particular row or column (step 560). Customizing the layout of the particular row or column can include performing any one or more of the customization operations previously described.

While input focus is on the particular row or column, the system 100 can receive keyboard input invoking additional functionality associated with the particular row or column (step 570). This action can occur instead of the action (step 550) of receiving keyboard input customizing the layout, or it can occur in addition.

The keyboard input can include keystrokes that invoke the additional functionality directly. Alternatively, the keyboard input can include keystrokes that cause the system 100 to display a menu that lists the additional functionality available.

The additional functionality can include any one or more of the additional functions previously described. One of these functions is a help function. Help information can be displayed as a small annotation beside the row or column; such annotations are commonly known as tool tips. Alternatively, the help information can be displayed in a separate help viewer program.

The keyboard controls 130 can include one or more of the following keyboard controls. In the following description, [key1]+[key2] refers to holding down [key1] and then pressing [key2].

Keyboard Controls to Establish Focus on Column or Row

[Alt]+[Up] to focus the columns

[Alt]+[Down] to unfocus the columns

[Alt]+[Left] to focus the rows

[Alt]+[Right] to unfocus the rows

Alternatively, to unfocus the columns, [Alt]+[Up] can be pressed a second time. Interpretation of the other keystrokes can be similarly configured.

When input focus is established on the rows or columns, it is initially established on a particular row or column. The following keyboard controls can be used to navigate to and establish input focus on a different row or column:

[Home] to navigate to and establish input focus on the first row or column

[End] to navigate to and establish input focus on the last row or column

[Left] to navigate to and establish input focus on the preceding row or column

[Right] to navigate to and establish input focus on the next row or column

Optionally, the table can be scrolled horizontally or vertically to display additional rows or columns. Some columns can be fixed columns, meaning that, no matter how the table is scrolled, the position of the fixed column will remain the same. Columns that are not fixed will be referred to as scrollable columns. The following keyboard controls can be used to skip the fixed columns:

[Home] to navigate to and establish input focus on the first scrollable column.

[End] to navigate to and establish input focus on the last scrollable column.

Pressing the [Home] or [End] keystroke a second time navigates to the next or previous scrollable column respectively.

[Ctrl]+[Home] to navigate to and establish input focus on the first scrollable row.

[Ctrl]+[End] to navigate to and establish input focus on the last scrollable row.

Optionally, some columns of the table can be displayed in a read-only state and cannot be edited. The following keyboard controls can be used to skip the read-only columns.

[Ctrl]+[Right] to navigate to and establish input focus on the next editable column

[Ctrl]+[Left] to navigate to and establish input focus on the previous editable column

Keyboard Controls to Rename a Column or Row Header

To rename a column row or header, the following keyboard control can be used, while input focus is established on the row or column header to be renamed:

[F2] to switch interaction mode from navigation mode to inline editing mode

Keyboard Controls to Resize a Column or Row

To resize a column or row, the following keyboard controls can be used, while input focus is established on the row or column to be resized:

[Shift]+[Right] to increase the width of a column by a predetermined number of pixels or characters

[Shift]+[Left] to decrease the width of a column by a predetermined number of pixels or characters

[Shift]+[Ctrl]+[Right] to increase the width of a column by a single pixel or character

[Shift]+[Ctrl]+[Left] to decrease the width of a column by a single pixel or character

[Shift]+[Up] to increase the width of a row by a predetermined number of pixels or characters

[Shift]+[Down] to decrease the width of a row by a predetermined number of pixels or characters

[Shift]+[Ctrl]+[Up] to increase the width of a row by a single pixel or character

[Shift]+[Ctrl]+[Down] to decrease the width of a row by a single pixel or character

Keyboard Controls to Reposition a Column or Row

To reposition a column or row, the following keyboard controls can be used, while input focus is established on the row or column to be repositioned:

[Ctrl]+[Arrow Right] to move the focused column after the next column

[Ctrl]+[Arrow Left] to move the focused column before the previous column

[Ctrl]+[Arrow Down] to move the focused row after the next row

[Ctrl]+[Arrow Up] to move the focused row before the previous row

Keyboard Controls to Sort a Column

To sort the contents of a column, the following keyboard controls can be used, while input focus is established on the column to be sorted:

[Shift]+[Ctrl]+[Up] to sort the contents of the focused column in ascending order

[Shift]+[Ctrl]+[Down] to sort the contents of the focused column in descending order

Keyboard Controls to Invoke Additional Functionality

[Ctrl]+[q] to display help information as a tool tip

[Ctrl]+[F1] to display help information in a separate help viewer

[Shift]+[F10] to display a menu of additional functionality

[Enter] or [Spacebar] to activate a particular operation mapped to the spacebar. This operation can be the same operation as the operation that is mapped to a mouse click. For example, this operation can be a column sort operation. The same keystroke can be pressed a second time to resort the column data in a different order, for example, descending instead of ascending.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described herein, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular implementations. Other implementations are within the scope of the following claims.

What is claimed is:

1. A computer program product, tangibly embodied in an information carrier, the computer program product including instructions operable to cause a computer to perform operations comprising:
displaying a table, the table including one or more rows and columns of data;
receiving keyboard input establishing input focus on a particular row or column of the table; and
while the input focus is established on the particular row or column, receiving keyboard input customizing the layout of the particular row or column and customizing the layout of the particular row or column in response to the received keyboard input.

2. The product of claim 1, wherein customizing the layout includes any one or more of renaming, resizing, reordering, or sorting the particular row or column.

3. The product of claim 1, wherein establishing input focus on a particular row or column includes:
visually marking the particular row or column with a marking that distinguishes the row or column from other rows or columns of the table.

4. The product of claim 1, wherein each row or column has a header area and establishing input focus on a particular row or column includes establishing input focus on the header area for the particular row or column.

5. The product of claim 1, wherein the operations further comprise:
prior to establishing input focus on a particular row or column, receiving keyboard input navigating between rows or columns of the table until the particular row or column is reached.

6. The product of claim 1, wherein the operations further comprise:
while input focus remains on the particular row or column, receiving keyboard input invoking additional functionality associated with the particular row or column.

7. The product of claim 6, wherein the additional functionality includes any one of a help function, a filter function, a data processing function, a column removal or a column addition function.

8. A method comprising:
displaying a table, the table including one or more rows and columns of data;
receiving keyboard input establishing input focus on a particular row or column of the table; and
while the input focus is established on the particular row or column, receiving keyboard input customizing the layout of the particular row or column and customizing the layout of the particular row or column in response to the received keyboard input.

9. The method of claim 8, wherein customizing the layout includes any one or more of renaming, resizing, reordering, or sorting the particular row or column.

10. The method of claim 8, wherein establishing input focus on a particular row or column includes:
visually marking the particular row or column with a marking that distinguishes the row or column from other rows or columns of the table.

11. The method of claim 8, wherein each row or column has a header area and establishing input focus on a particular row or column includes establishing input focus on the header area for the particular row or column.

12. The method of claim 8, further comprising:
prior to establishing input focus on a particular row or column, receiving keyboard input navigating between rows or columns of the table until the particular row or column is reached.

13. The method of claim 8, wherein the operations further comprise:
while input focus remains on the particular row or column, receiving keyboard input invoking additional functionality associated with the particular row or column.

14. The method of claim 13, wherein the additional functionality includes any one of a help function, a filter function, a data processing function, a column removal or a column addition function.

15. A system comprising:
means for displaying a table, the table including one or more rows and columns of data;
means for receiving keyboard input establishing input focus on a particular row or column of the table; and
means for, while the input focus is established on the particular row or column, receiving keyboard input customizing the layout of the particular row or column and customizing the layout of the particular row or column in response to the received keyboard input.

16. The system of claim 15, wherein the means for customizing the layout includes any one or more of means for renaming, resizing, reordering, or sorting the particular row or column.

17. The system of claim 15, wherein the means for establishing input focus on a particular row or column includes:
means for visually marking the particular row or column with a marking that distinguishes the row or column from other rows or columns of the table.

18. The system of claim 15, further comprising:
means for, prior to establishing input focus on a particular row or column, receiving keyboard input navigating between rows or columns of the table until the particular row or column is reached.

19. The system of claim 15, further comprising:
means for, while input focus remains on the particular row or column, receiving keyboard input invoking additional functionality associated with the particular row or column.

20. The system of claim 19, wherein the additional functionality includes any one of a help function, a filter function, a data processing function, a column removal or a column addition function.
